(19) United States
(12) Patent Application Publication
(10) Pub. No.: US 2013/0188443 A1
(43) Pub. Date: Jul. 25, 2013

(54) Reversible Blender Jug

(71) Applicant: Christina Ruth Alvarez, Austin, TX (US)

(72) Inventor: Christina Ruth Alvarez, Austin, TX (US)

(21) Appl. No.: 13/353,908

(22) Filed: Jan. 19, 2012

(51) Int. Cl. B01F 7/16

(52) U.S. Cl. 366/205

(57) ABSTRACT

The reversible blender jug is one embodiment of a blender jug, comprising a vessel with dual and opposing openings, a plurality of lids (some having attached agitators), and a means for securing said lids to said vessel. The reversible blender jug can be operated in an upright or inverted position. Inverting the blender jug imparts vertical movement to the contents, creating more frequent contact between the agitators and the contents.

### FIELD OF THE DISCLOSURE

The disclosures made herein relate to blenders generally, and more particularly, to a reversible blender jug that can be operated in an upright or inverted position.

### BACKGROUND

Prior Art

The following is a tabulation of some prior art that presently appears relevant:

U.S. Patents

| Patent Number | Kind Code | Issue Date | Patentee |
|---|---|---|---|
| 2,733,052 | A | 1956 Jan. 31 | Luther |
| 3,417,972 | A | 1968 Dec. 24 | Vincent |
| 3,784,118 | A | 1974 Jan. 08 | Hurwitz |
| 3,895,548 | A | 1975 Jul. 02 | Sauve |
| 4,030,707 | A | 1977 Jun. 21 | Moreton |
| 5,839,826 | A | 1998 Nov. 24 | Eubanks |
| 6,981,795 | A | 2000 Jan. 11 | Thuma |
| 6,666,574 | B1 | 2003 Dec. 23 | Pryor |
| 6,935,767 | B2 | 2005 Aug. 30 | Nikkhah |
| 6,981,795 | B2 | 2006 Jan. 03 | Nikkhah |
| 2008/0170465 | A1 | 2008 Jul. 17 | Bohannon |

A blender is a household appliance used to blend food and drinks. Generally, a blender will include a blender jug in addition to a fixed base that encases a motor having a drive shaft extending vertically therefrom. The blender jug includes an agitator attached for driving engagement with the motor shaft.

A common problem with many prior art blenders is the tendency of contents to form a bridge over the agitators, hindering the desired vortex-like flow of unprocessed contents towards the blade and of processed contents away from the blades. As a result, In order to obtain a complete and homogenous mixture, users often must assist the mixing process, using a tool that is external to the blender (such as a spoon, spatula, whisk, etc.) or some other external means (such as shaking or jostling the blender jug.

Hitherto, blender jugs have typically had one opening and operated in a given upright position. One difficulty with this configuration is the incomplete processing of contents. The single opening configuration does not promote sufficient movement in the contents of the blender and often results in lengthy blending times or inadequate blending. Another problem is the difficulty of cleaning the components of the single-opening blender jug.

Therefore, a blender jug configuration that enhances the cleaning and mixing performance of the blender would be beneficial, desirable and useful.

### SUMMARY OF DISCLOSURE

The reversible blender jug is one embodiment of a blender jug, comprising a vessel with dual and opposing openings, a plurality of lids (some having attached agitators), and a means for securing said lids to said vessel. The reversible blender jug can be operated in an upright or inverted position.

### Advantages

Accordingly, a number of advantages of some embodiments of the reversible blender jug are as follows:

(a) The dual openings of the vessel allow for agitators to attach at both ends, permitting users to invert the blender jug to impart vertical movement to the contents, thereby increasing interaction between contents and agitators, and producing a faster and more complete mixture of contents

(b) The plurality of lids with no attached agitators allow users to convert the vessel into a portable drinking device

(c) The dual openings and removable agitators enhance the ability of users to clean the blender jug components

### BRIEF DESCRIPTION OF THE DRAWINGS

FIG. 1 is a side view of one embodiment.

FIG. 2 is a disassembled view of one embodiment.

FIG. 3 is a side view of the vessel of one embodiment.

FIG. 4 Is a side view of lids without agitators of one embodiment.

FIG. 5 Is a side view of the lids with agitators of one embodiment.

### REFERENCE NUMERALS OF THE DRAWINGS

10— Vessel

12— Opening

14—Lid

16—Agitator

### DETAILED DESCRIPTION OF THE DRAWINGS

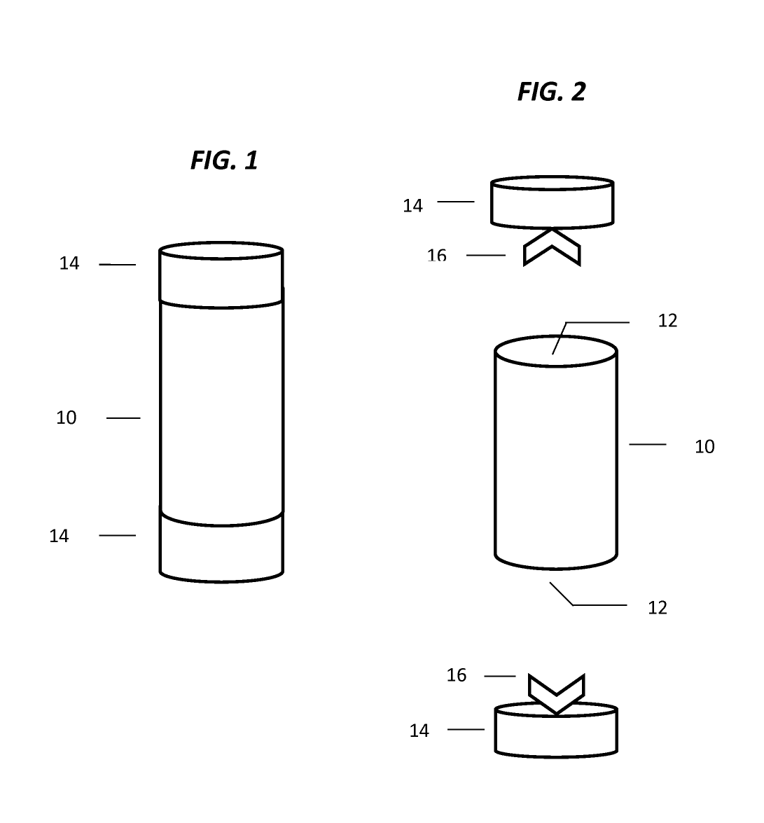

First Embodiment—FIGS. 1 and 2

One embodiment of the reversible blender jug is illustrated in FIGS. 1 and 2. The plastic vessel 10 has dual and opposing openings 12 that connect to screw-on plastic lids 14. These lids 14 have metal blade agitators 16 attached.

### Operation

First Embodiment—FIGS. 1 and 2

The manner of using the reversible blender jug is different from that of previous blender jugs, because the user can, when desired, invert the orientation of the blender jug in order to quickly and easily obtain a more homogenous mixture of its contents. Additionally, by unscrewing the lids from the vessel, the user can clean the components of the blender jug quickly and effectively.

### Detailed Description of the Drawings

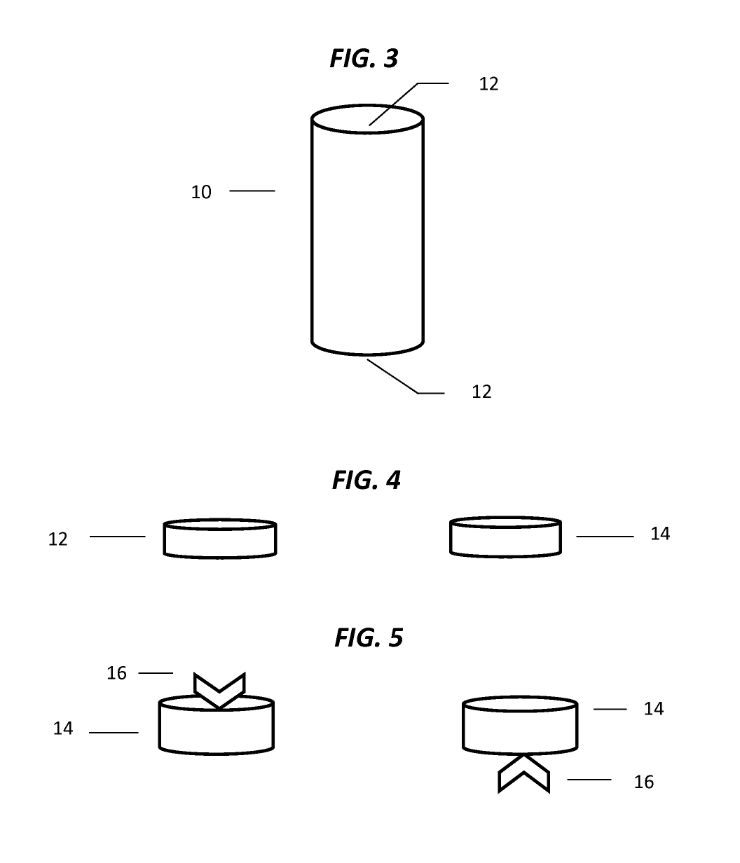

Alternative Embodiment—FIGS. 3, 4, and 5

One embodiment of the reversible blender jug is illustrated in FIGS. 3, 4, and 5. The glass vessel 10 is shaped like a cylinder with dual and opposing openings 12. The openings 12 of the vessel 10 connect to a plurality of screw-on, water-tight plastic lids 14. Some of these lids 14 have attached metal agitators 16, while some of them do not have any agitators 16 attached.

### Operation

Alternative Embodiment—FIGS. 3, 4, and 5

The manner of using the reversible blender jug is different from that of previous blender jugs, because the user can, when desired, invert the orientation of the blender jug in order to obtain a more homogenous mixture of contents. Additionally, by unscrewing the lids 14 from the vessel 10, the user can quickly and easily clean the components of the blender jug. Furthermore, the plurality of lids 14 offers enhanced versatility by allowing users to attach lids 14 without agitators 16, when desired, to convert the vessel into a portable drinking device.

### Conclusion, Ramifications and Scope

In accordance with one embodiment of the invention, I have provided a reversible blender jug that can be operated in an upright or inverted position, in order to provide a homogenous mixture of contents quickly. Additionally, with various lid designs and configurations, the blender jug can be easily converted into a portable drinking container, offering added versatility of use. Furthermore, the dual and opposing openings allow for quick and easy cleaning of the blender jug components.

While the above description contains many specificities, these should not be construed as limitations on the scope of any embodiment, but as exemplifications of various embodiments therof. Many other ramifications and variations are possible within the teachings of the various embodiments. For example, a handle could be added to the vessel to enhance portability and comfort.

Thus the scope should be determined by the appended claims and other legal equivalents, and not by the examples given.

1. A reversible blender jug, comprising:
a container having dual and opposing openings;
a plurality of lids each having an attached agitator; and
a means for securing said lids to the container, wherein the means for securing said lids enables a first one of said lids to be secured to the container for covering a first one of said openings and a second one of said lids to be secured to the container for covering a second one of said openings.

2. The reversible blender jug of claim 1 wherein said openings of the container are of equal size.

3. The reversible blender jug of claim 1 wherein said openings of the container are not of equal size.

4. The reversible blender jug of claim 1 wherein said lids are of equal size.

5. The reversible blender jug of claim 1 wherein said lids are not of equal size.

6. The reversible blender jug of claim 1 wherein the means for securing said lids enables at least one of the first one of said lids to be screwed onto the container and the second one of said lids to be screwed onto the container.

7. The reversible blender jug of claim 1 wherein the means for securing said lids enables at least one of the first one of said lids to be clicked into the container and the second one of said lids to be clicked into the container.

8. The reversible blender jug of claim 1 wherein said container has a handle.

9. The reversible blender jug of claim 1 wherein said container has a plurality of handles.

10. The reversible blender jug of claim 1 wherein said agitators are removable from said lids.

11. A reversible blender jug,. comprising:
a container having a plurality of openings;
a plurality of lids each having an attached agitator; and
a means for securing said lids to the container, wherein the means for securing said lids enables a first one of said lids to be detachably engaged with the container for covering a first one of said openings and a second one of said lids to be detachably engaged with the container for covering a second one of said openings while the first one of said lids is engaged with the container.

12. The reversible blender jug of claim 11 wherein the container is shaped like a sphere.

13. The reversible blender jug of claim 11 wherein the container is shaped like an ellipsoid.
